(19) United States
(12) Patent Application Publication
(10) Pub. No.: US 2011/0141531 A1
(43) Pub. Date: Jun. 16, 2011

(54) Image Processing Device

(75) Inventor: Shuji KAWAKATSU, Kyoto-shi (JP)

(73) Assignee: MURATA MACHINERY, LTD., Kyoto-shi (JP)

(21) Appl. No.: 12/961,409

(22) Filed: Dec. 6, 2010

(30) Foreign Application Priority Data
Dec. 10, 2009 (JP) 2009-280968

(51) Int. Cl. H04N 1/32

(52) U.S. Cl. 358/442

(57) ABSTRACT

An image processing unit has a main body unit including scanner, facsimile and display sections, and a first control section for controlling the scanner, facsimile and display sections. A network unit includes a second control section for controlling exchange of information through an interface section. A bus connects the main body and network units. An image processing unit, connected to the bus, processes image data generated by the scanner or facsimile section according to a request of the first or second control section. The display section displays an image indicated in the processed image data acquired by the main body unit, and the interface section transmits the processed image data acquired by the network unit to an external network.

### CROSS-REFERENCE TO RELATED APPLICATIONS

This application claims priority under 35 U.S.C. 119 to Japanese Patent Application No. 2009-308348, filed on Dec. 10, 2009, which application is hereby incorporated by reference in its entirety.

### BACKGROUND OF THE INVENTION

1. Field of the Invention

The present invention relates to an image processing device such as a multi-function peripheral having a scanner function and a facsimile communication function.

2. Description of the Related Art

In recent years, network multi-function peripherals (hereinafter referred to as multi-function peripherals) that are image processing devices having a printer function, a scanner function, a facsimile communication function, a network communication function, and the like in one device are becoming popular in an aim of saving space.

Such multi-function peripherals must not only print out images acquired by the scanner and the like, but must also transmit data of the image to another device through a network such as a Local Area Network (LAN). For example, there is a network multi-function peripheral capable of being connected to the Internet through a LAN and having a function of performing facsimile communication via the Internet (hereinafter referred to as “Internet facsimile function”).

In a network multi-function peripheral having the Internet facsimile function, for example, an image of a document is scanned with the scanner, image data indicating the image is generated, and the generated image data is sent to a designated destination via the Internet.

Furthermore, image processing such as a reduction process is performed to accord with, for example, the standard of the facsimile communication when generating the image data.

In one technique in a network multi-function peripheral having an Internet facsimile function, image processing dedicated to Internet facsimile is performed when Internet facsimile is selected by a user. Thus, degradation in the quality of an image transmitted by Internet facsimile is suppressed.

Recent network multi-function peripherals are desired not only to perform image processing dedicated to Internet facsimile as described above, but also to have an image processing function for generating a thumbnail-size image to output to an external network. This is to allow a user to check an image acquired by a network multi-function peripheral with the scanner or facsimile communication function on a personal computer (hereinafter referred to as “PC”) before printing out the image. Therefore, a network multi-function peripheral for transmitting a thumbnail-size image to a PC connected through a LAN also exists.

In such a network multi-function peripheral, thumbnail-size image data of the image is generated by conversion of the resolution with respect to the acquired image. Furthermore, the generated thumbnail-size image data is transmitted through the LAN to the PC requesting the thumbnail.

An image processing unit that performs such a reduction process is, for example, mounted on a circuit board configuring a network unit that becomes an interface with the LAN, and has the operation controlled by a control section of the network unit. The generation of the thumbnail-size image and the transmission of the thumbnail through the LAN are then efficiently carried out.

Recently, displays configuring a display section of an operation panel or the like have higher definitions and lower prices. Consequently, a network multi-function peripheral mounted with a display section having a relatively large display area also exists. As a result, there is demand to display the thumbnail-size image not only on the PC that is an external terminal device, but also on the display section of the network multi-function peripheral.

Therefore, a configuration in which the image processing unit is arranged in the network unit for the network multi-function peripheral may be considered. In this case, a main body unit always needs to access the image processing unit through the control section of the network unit, and operate the image processing unit to display the thumbnail on the display section of the operation panel or the like of the main body unit. Therefore, it is difficult to enhance the processing efficiency related to displaying the thumbnail on the main body unit.

Providing the image processing unit for generating the thumbnail-size image in the main body unit may also be considered. In this case, however, another problem in increased manufacturing cost arises.

### SUMMARY OF THE INVENTION

In view of the above problems, it is an object of the present invention to provide an image processing device having a network communication function, and efficiently performing a process of displaying an acquired image on both a main body unit and another device connected through an external network.

According to an embodiment of the present invention, an image processing device includes a scanner section for scanning an image of a document and generating image data; a facsimile section for generating image data from a received facsimile signal; a display section for displaying an image; a first control section for controlling the scanner section, the facsimile section, and the display section; an interface section for exchanging information with an external network; a network unit including a second control section for controlling the exchange of information through the interface section; a bus for connecting a main body unit and the network unit; and an image processing unit, connected to the bus, for performing processing of the image data generated by the scanner section or the facsimile section according to a request of the first control section or the second control section; wherein the display section displays an image based on the processed image data acquired by the main body unit; and the interface section transmits the processed image data acquired by the network unit to the external network.

According to this configuration, both the main body unit and the network unit can easily access the image processing unit. That is, the processing request with respect to the image processing unit and the acquisition of the processed image data by both the main body unit and the network unit become more efficient.

Therefore, an image processed by the image processing unit can be easily displayed on both the display section of the main body unit and another device such as a PC connected through a network.

According to one embodiment of the present invention, the image processing unit exists as a processing unit independent from the main body unit and the network unit. The main body unit and the network unit communicate irrespective of the presence of the image processing unit since the main body unit and the network unit are directly connected with a bus.

According to this configuration, when designing and manufacturing a plurality of types of network multi-function peripherals, the configuration can be shared between a type including the image processing unit and a type not including the image processing unit. As a result, design and manufacturing costs of such types can be suppressed.

According to another embodiment of the present invention, a circuit board independent from the main body unit and the network unit is provided, and the image processing unit is arranged on the circuit board.

According to this configuration, the image processing unit is arranged on the circuit board independent from the main body unit and the network unit. Thus, the detachment of the image processing unit from the image processing device, and the attachment of the image processing unit to the image processing device are facilitated.

Therefore, the main configuration of the image processing device of the present invention can be used as is when designing and manufacturing a multi-function peripheral that does not require the image processing unit and that simply requires only the network interface. As a result, design and manufacturing costs of the multi-function peripheral can be suppressed.

According to another embodiment of the present invention, the image processing unit generates the processed image data by converting a resolution of an image in the image data generated by the scanner section or the facsimile section.

According to this configuration, a thumbnail corresponding to the space of the display area of the display section or another device such as the PC, the number of images to be displayed simultaneously, and the like can be easily generated.

According to another embodiment of the present invention, the bus is a Peripheral Component Interconnect (PCI) bus; and the first control section and the second control section each access the image processing unit by specifying a predetermined address.

According to this configuration, high-speed communication is easily realized among the main body unit, the network unit, and the image processing unit, and an image processing device having high expandability is realized.

According to another embodiment of the present invention, the network unit further includes a storage unit for storing the image data generated by the scanner section or the facsimile section; and the image processing unit generates the processed image data by reading and processing the image data stored in the storage unit, and writes the generated processed image data again to the storage unit.

According to this configuration, the main body unit does not need to accumulate the image data processed by the image processing unit in a memory, and can acquire the processed image data accumulated in the network unit and display the same on the display section. That is, efficient use of the processed image data is realized.

As is apparent from the above description, use of the image processing unit from both the main body unit and the network unit is easy in the image processing device according to the present invention. In other words, the present invention provides an image processing device that efficiently performs the process of displaying the acquired image on both the main body unit and another device connected through the external network.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a view illustrating a configuration of an image processing system including an image processing device of the present invention.

FIG. 2 is a block diagram illustrating a characteristic functional configuration of the image processing device of the present invention.

FIG. 3 is a block diagram illustrating a main hardware configuration of the image processing device of the present invention.

FIG. 4 is a view illustrating a first example of a flow of processes of the image processing device of the present invention.

FIG. 5 is a view illustrating a second example of the flow of processes of the image processing device of the present invention.

FIG. 6 is a view illustrating a state in which the image processing device of the present invention is displaying a thumbnail-size image on both an operation panel and a terminal device.

FIG. 7 is a view illustrating a connection mode of a main body unit, a network unit, and an image processing unit of the image processing device of the present invention.

FIG. 8 is a view illustrating one example of a connection mode of the main body unit and the network unit of the image processing device of the present invention.

### DETAILED DESCRIPTION OF EMBODIMENTS OF THE INVENTION

Embodiments of the present invention are now described with reference to the drawings.

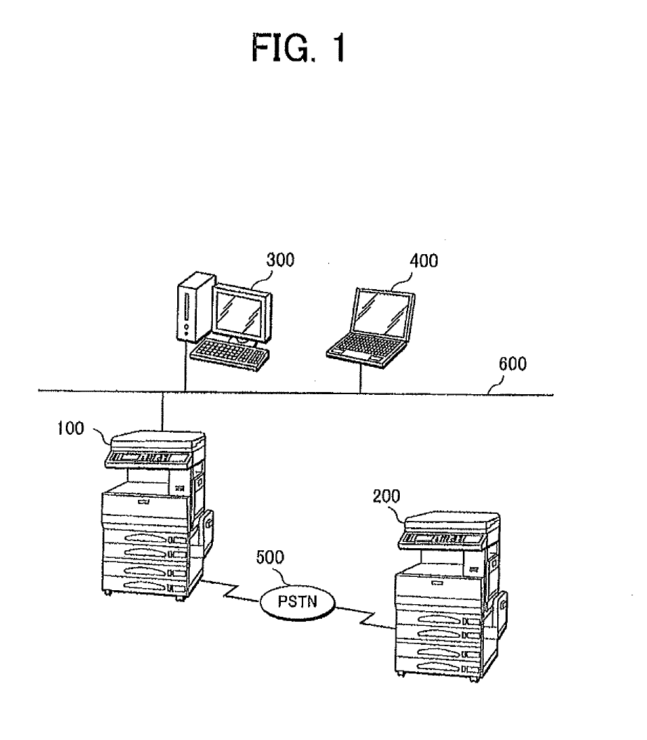

FIG. 1 illustrates an image processing system including an image processing device 100 according to an embodiment of the present invention. The image processing device 100 is connected to an image processing device 200, which is a counterpart of transmission or reception of a facsimile, through a Public Switched Telephone Network (PSTN) 500. The image processing device 100 is also connected to a terminal device 300 and a terminal device 400 through a LAN 600. The image processing device 100 is, for example, a multifunction peripheral (MFP) and is a device for processing image data.

The terminal devices 300 and 400 access the image processing device 100 through the LAN 600, and transmit various requests such as print requests, or image data and the like associated with such requests, to the image processing device 100. The terminal devices 300 and 400 can also reference or change various settings of the image processing device 100.

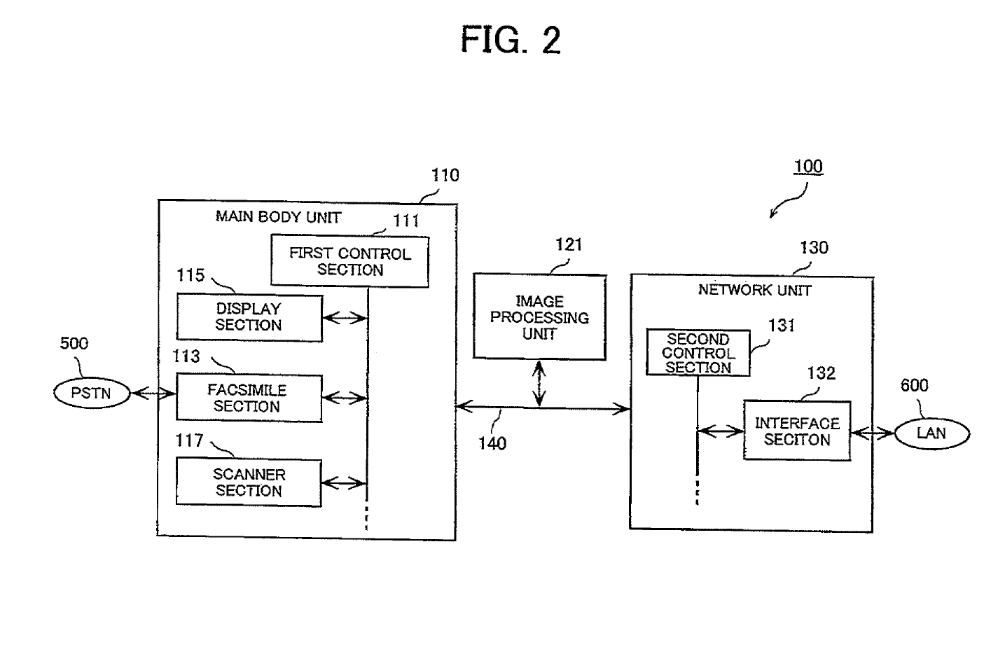

FIG. 2 illustrates a characteristic functional configuration of the image processing device 100. The image processing device 100 includes a main body unit 110, an image processing unit 121, and a network unit 130. The main body unit 110 and the network unit 130 are connected by a PCI bus 140, and the image processing unit 121 is connected to the PCI bus 140.

The main body unit 110 includes a first control section 111, a facsimile section 113, a scanner section 117, and a display section 115. The scanner section 117 scans an image represented on a document and generates image data. The facsimile section 113 generates image data from a received facsimile signal. The display section 115 displays an image based on image data processed by the image processing unit 121.

The first control section 111 controls the operation of the facsimile section 113, the scanner section 117, and the display section 115. The first control section 111 also accesses the image processing unit 121 through the PCI bus 140, and makes a request to process image data generated by the scanner section 117 or the facsimile section 113.

The network unit 130 includes a second control section 131 and an interface section 132. The interface section 132 exchanges data with the LAN 600, which is an external network. The second control section 131 controls the exchange of data through the interface section 132. The second control section 131 accesses the image processing unit 121 through the PCI bus 140, and makes a request to process image data generated by the scanner section 117 or the facsimile section 113.

The image processing unit 121 processes image data generated by the scanner section 117 or the facsimile section 113 in response to a request of the first control section 111 or the second control section 131, respectively. The first control section 111 and the second control section 131 can respectively specify a predetermined address and access the image processing unit 121.

In the present embodiment, the image processing unit 121 reduces the image and generates thumbnail-size image data (hereinafter referred to as “thumbnail data”) of the image by changing the resolution of the image in the image data.

A user can check an image acquired by the scanner section 117 or the facsimile section 113 with the thumbnail displayed on the display section 115 of the main body unit 110. The user may also display the thumbnail on the terminal device 300 or 400 by requesting the image processing device 100 from the terminal device 300 or 400. In other words, the user can check an image acquired by the image processing device 100 with not only the display section 115 of the image processing device 100, but also with the terminal devices 300 and 400.

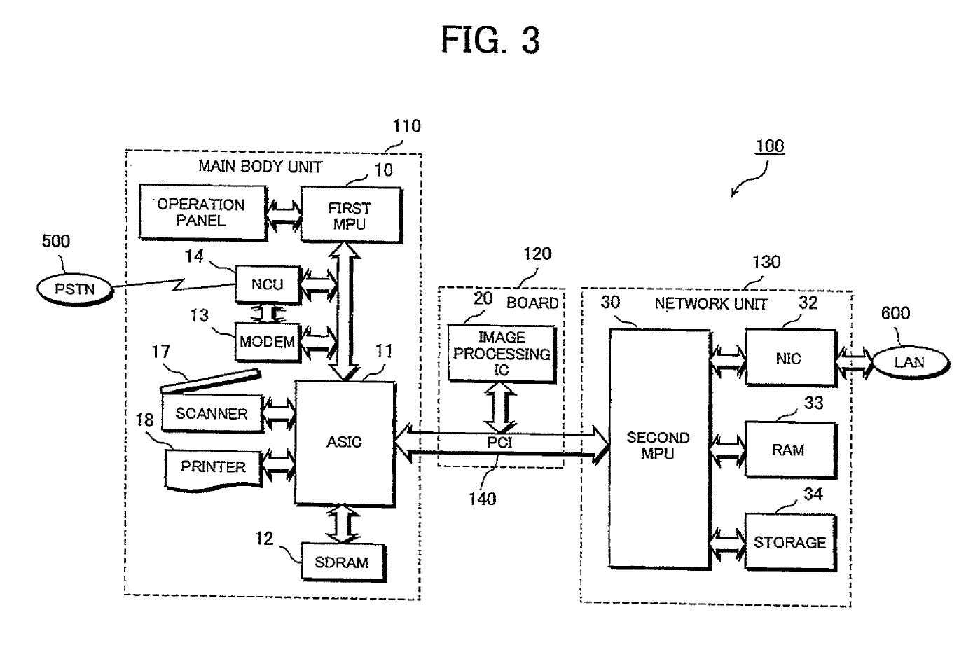

The hardware configuration of the image processing device 100 having such a function is described with reference to FIG. 3. The main body unit 110 of the image processing device 100 includes a first Micro Processing Unit (MPU) 10, an Application Specific Integrated Circuit (ASIC) 11, a Synchronous DRAM (SDRAM) 12, a modem 13, a Network Control Unit (NCU) 14, an operation panel 15, a scanner 17, and a printer 18.

The first MPU 10 is a processor corresponding to the first control section 111 in FIG. 2. The first MPU 10 reads and executes the control program stored in a ROM.

The ASIC 11 is hardware that performs image processing such as error diffusion on image data inputted from the scanner 17, and the like, and writes the same on the SDRAM 12. The ASIC 11 also functions as a bridge between the scanner 17 and the printer 18, and the SDRAM 12.

The SDRAM 12 is a volatile storage medium that operates in synchronization with an external clock. Specifically, the SDRAM 12 temporarily holds image data acquired by the modem 13 and the scanner 17, as described above.

The modem 13 is a facsimile modem that modulates facsimile transmitted image data, or demodulates image data facsimile transmitted from the outside. The NCU 14 controls the connection of the PSTN 500 and the modem 13. The modem 13 and the NCU 14 realize the facsimile communication function of the facsimile section 113 illustrated in FIG. 2.

The scanner 17 is hardware corresponding to the scanner section 117 of FIG. 2. The scanner 17 is a device that generates image data by optically scanning an image (including characters) represented on the front or the back of a document using a Charge Coupled Device (CCD) line image sensor and the like.

The printer 18 is a device that prints images represented by image data received from the terminal devices 300 and 400 through the LAN 600, or images based on image data generated by the scanner 17 on a medium such as paper.

The operation panel 15 is a device corresponding to the display section 115 of FIG. 2. The operation panel 15 receives an input from the user and displays the information with images, characters, and the like. The display section of the operation panel 15 is realized by a Liquid Crystal Display (LCD) or the like.

An image processing IC 20 is an IC corresponding to the image processing unit 121 of FIG. 2. In the present embodiment, the image processing IC 20 is mounted on a circuit board 120 independent from the main body unit 110 and the network unit 130. The image processing IC 20 is connected to the PCI bus 140 that connects the main body unit 110 and the network unit 130.

The image processing IC 20 receives image data from the main body unit 110 via the PCI bus 140. The image processing IC 20 also changes the resolution of the received image data. Thumbnail data thus can be generated while reducing an image to a size corresponding to a value set by the user from the operation panel 15, or to a set value transmitted via the LAN 600. The thumbnail data generated by the image processing IC 20 is stored in a storage 34 of the network unit 130.

The network unit 130 includes a second MPU 30, a Network Interface Card (NIC) 32, a RAM 33, and the storage 34. Each component of the network unit 130 such as the second MPU 30 is mounted on one or a plurality of circuit boards separate from the circuit board 120.

The second MPU 30 is a processor corresponding to the second control section 131 in FIG. 2, and controls other components of the network unit 130 such as the NIC 32.

The NIC 32 corresponds to the interface section 132 in FIG. 2, and is hardware for connecting the image processing device 100 to the LAN 600.

The RAM 33 is a volatile storage medium from which information can be read and to which information can be written. The RAM 33, for example, temporarily stores programs to be executed by the second MPU 30.

The storage 34 is a storage device for storing processed image data obtained from the image processing IC 20. For example, the storage 34 may be a non-volatile storage device such as a Compact Flash (registered trademark).

The first MPU 10 of the main body unit 110 has a bus arbitration function. That is, when the main body unit 110 and the network unit 130 compete for access to the image processing IC 20, the first MPU 10 determines which one of the main body unit 110 or the network unit 130 can use the image processing IC 20.

In the image processing device 100 configured as above, image processing is performed by the image processing IC 20 on image data generated by the scanner 17 or the like of the main body unit 110, thereby obtaining thumbnail data. The image processing is carried out based on the request from the first MPU 10 or the second MPU 30.

A plurality of pieces of thumbnail data generated by the image processing IC 20 are stored in the storage 34. An image based on such thumbnail data is displayed on the operation panel 15 of the main body unit 110, as well as on the terminal devices 300 and 400 connected to the LAN 600.

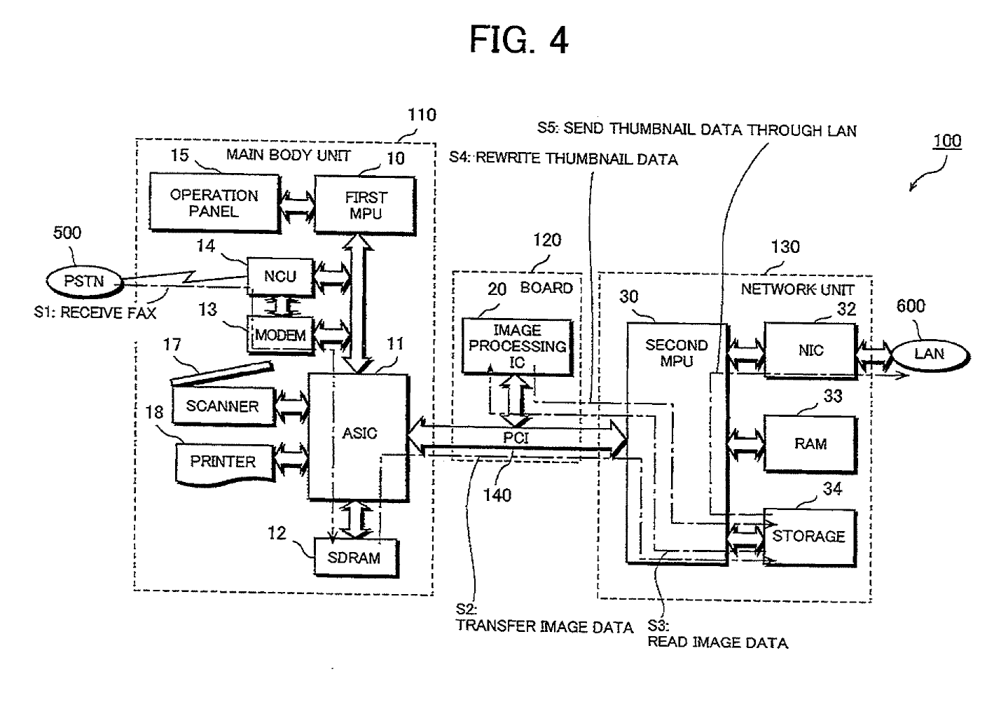

The flow of processes related to the thumbnail of the image processing device 100 and the results thereof is described with reference to FIGS. 4 to 6. FIG. 4 illustrates a first example of the flow of processes of the image processing device 100, specifically, FIG. 4 illustrates a flow of data in the case when the image processing device 100 sends to the LAN 600 a thumbnail of an image obtained through facsimile reception.

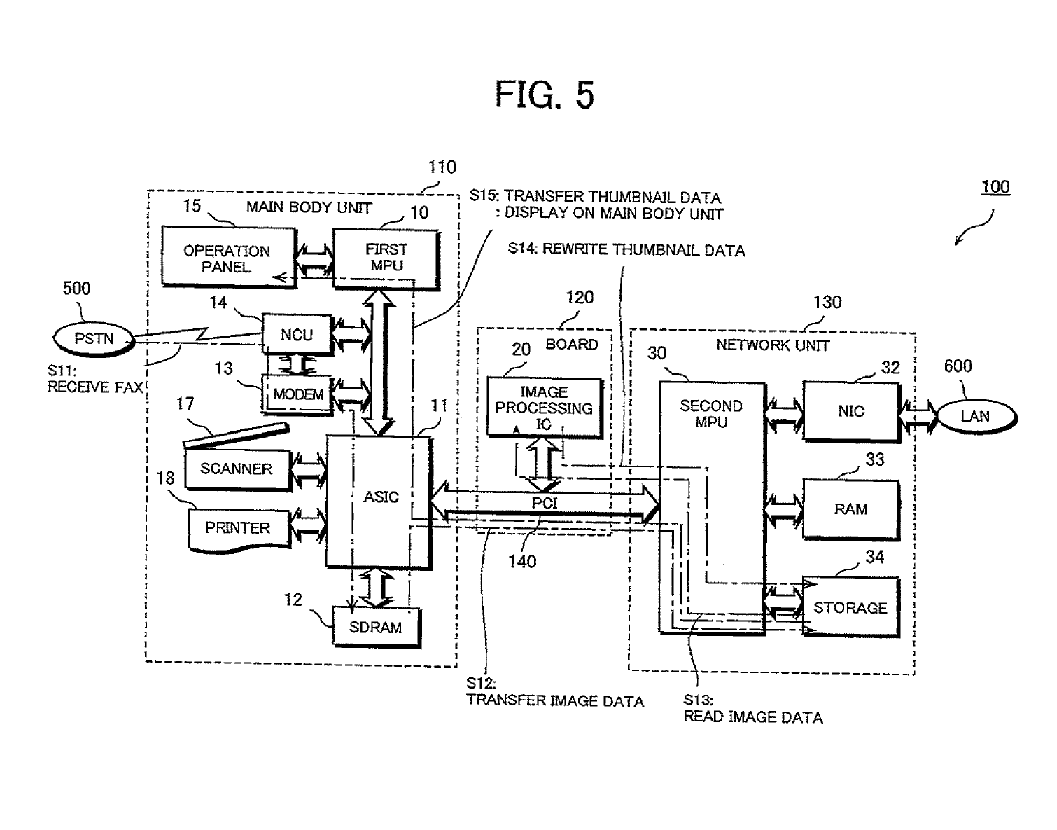

The operation of each component of the main body unit 110 described with reference to FIGS. 4 and 5 is controlled by the first MPU 10, and the operation of each component of the network unit 130 is controlled by the second MPU 30.

As illustrated in FIG. 4, when the NCU 14 receives a facsimile signal through the PSTN 500 (S1), the signal is demodulated by the modem 13, thereby obtaining image data. The image data is then written to the SDRAM 12 by the ASIC 11. The image data written to the SDRAM 12 is read out to the ASIC 11, and transferred to the storage 34 of the network unit 130 through the PCI bus 140 (S2).

Thereafter, the second MPU 30 instructs the process with respect to the image data stored in the storage 34 to the image processing IC 20 in response to a request to acquire thumbnail data from the terminal device 300 through the LAN 600. The image data is then read from the storage 34 and inputted to the image processing IC 20 through the PCI bus 140 according to such an instruction (S3).

The image processing IC 20 generates thumbnail data by changing the resolution of the image in the acquired image data. A set value transmitted from the terminal device 300 through the LAN 600 is used for the image size and the like of the thumbnail data to be generated. The second MPU 30 receives the set value and transmits the set value to the image processing IC 20 through the PCI bus 140. The transmitted set value is written to a register of the image processing IC 20. The image processing IC 20 generates thumbnail data from the image data according to the set value written to the register.

The thumbnail data generated by the image processing IC 20 is transmitted to the second MPU 30 through the PCI bus 140, and is written to the storage 34 by the second MPU 30. That is, the image data processed by the image processing IC 20 is written again to the storage 34 (S4).

Subsequently, the second MPU 30 reads out the thumbnail data from the storage 34 and sends out the thumbnail data to the terminal device 300 through the NIC 32 as a response to the request to acquire the thumbnail data (S5).

In this manner, image data based on a facsimile signal received by the main body unit 110 of the image processing device 100 is once stored in the storage 34 of the network unit 130, and then processed by the image processing IC 20. Thumbnail data obtained by the image processing is written again to the storage 34, and then transmitted to an external device such as the terminal device 300 requesting the thumbnail data through the LAN 600.

FIG. 4 illustrates the flow of processes of transmitting a thumbnail of an image obtained by facsimile communication to an external device via the LAN 600. However, the image processing device 100 may generate and transmit thumbnail data to an external device via the LAN 600 in a similar fashion for an image acquired by the scanner 17.

The reading of image data from the storage 34 (S3) and the writing of a thumbnail based on the image data to the storage 34 (S4) may be carried out without waiting for a request from an external device such as the terminal device 300.

In this case, for example, the second MPU 30 may instruct the generation of a thumbnail based on image data to the image processing IC 20 after confirming that the image data generated by the main body unit 110 is stored in the storage 34. Thumbnail data corresponding to the image data is thereby generated and stored in the storage 34. When the second MPU 30 subsequently receives a request to acquire thumbnail data from an external device such as the terminal device 300, the thumbnail data already stored in the storage 34 is transmitted as a response with the external device as a destination.

Next, the flow of processes in a case when the image processing device 100 displays a thumbnail of an acquired image on the operation panel 15 of the main body unit 110 is described with reference to FIG. 5, FIG. 5 illustrates a second example of the flow of processes of the image processing device 100, specifically, FIG. 5 illustrates the flow of data in a case when the image processing device 100 displays a thumbnail of an image obtained through facsimile reception on the operation panel 15.

As illustrated in FIG. 5, the processes from the reception of a facsimile signal by the NCU 14 (S11) to the transfer of image data based on the facsimile signal to the storage 34 (S12) are the same as the flow of processes (S1 and S2) of FIG. 4.

The first MPU 10 thereafter instructs the process with respect to the image data stored in the storage 34 to the image processing IC 20 in response to a request to display a thumbnail from the operation panel 15 by the user. The image data is then read from the storage 34 and acquired by the image processing IC 20 through the PCI bus 140 according to such an instruction (S13).

The image processing IC 20 generates thumbnail data by changing the resolution of the image in the acquired image data. As for the image size or the like of the thumbnail data to be generated at this time, a set value inputted from the operation panel 15 by the user is used. The first MPU 10 receives the set value and transmits the set value to the image processing IC 20 through the PCI bus 140. The transmitted set value is written to the register of the image processing IC 20. The image processing IC 20 generates thumbnail data according to the set value written to the register.

The thumbnail data generated by the image processing IC 20 is written again to the storage 34 (S14). Subsequently, the first MPU 10 acquires the thumbnail data from the storage 34 through the PCI bus 140 and displays the image indicated in the thumbnail data on the operation panel 15 as a response to the request to display the thumbnail from the user (S15).

In this manner, image data based on a facsimile signal received by the main body unit 110 of the image processing device 100 is once stored in the storage 34 of the network unit 130, and then processed by the image processing IC 20. Thumbnail data obtained by the image processing is written again to the storage 34, acquired by the main body unit 110 through the PCI bus 140, and then displayed on the operation panel 15.

FIG. 5 illustrates the flow of processes in displaying a thumbnail of an image obtained by facsimile communication on the operation panel 15. However, the image processing device 100 may generate and display a thumbnail on the operation panel 15 in a similar fashion for an image acquired by the scanner 17.

The processes from the reading of image data from the storage 34 (S13) and the writing of a thumbnail based on the image data to the storage 34 (S14) may be carried out without waiting for a request to display a thumbnail from the user.

In this case, for example, the first MPU 10 may instruct the generation of a thumbnail based on the image data to the image processing IC 20 after confirming that the image data is transferred from the SDRAM 12 to the storage 34. Thumbnail data corresponding to the image data is thereby generated and stored in the storage 34. When the first MPU 10 subsequently receives a request to display a thumbnail from the operation panel 15, the thumbnail data already stored in the storage 34 is acquired and displayed on the operation panel 15 as a response.

Therefore, in the image processing device 100 according to the present embodiment, the main body unit 110 and the network unit 130 are connected with the PCI bus 140, and the image processing unit 121 is connected to the PCI bus 140. Therefore, in addition to the access between the main body unit 110 and the network unit 130 being facilitated, the image processing unit 121 can be easily accessed from both the main body unit 110 and the network unit 130. As a result, a thumbnail obtained by the image processing unit 121 can be easily displayed on the main body unit, and furthermore, the thumbnail can be easily displayed on another device connected through the external network.

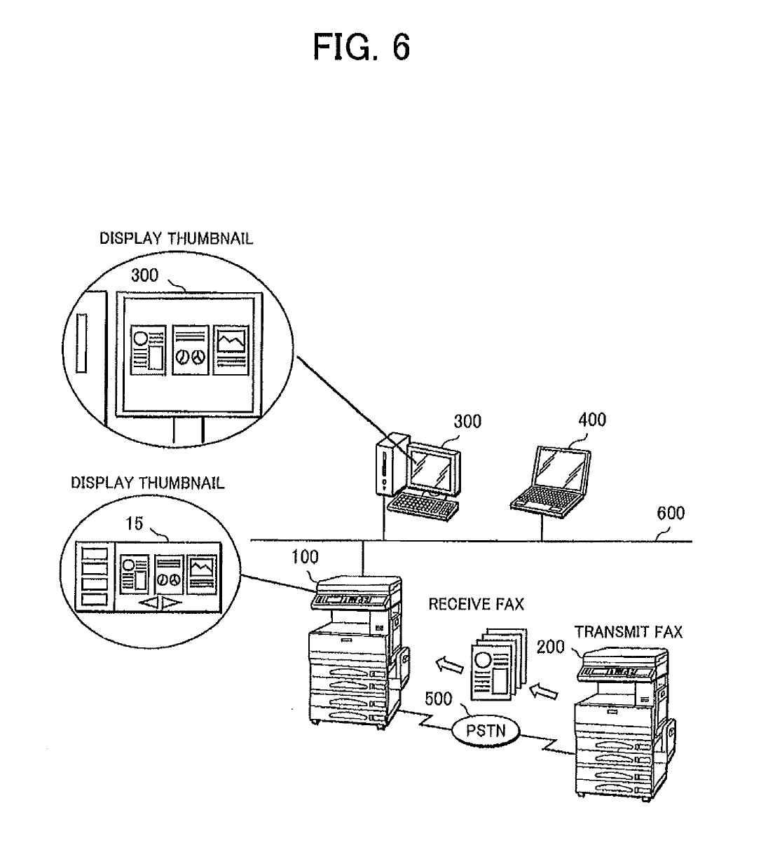

FIG. 6 illustrates a state in which the image processing device 100 is displaying a thumbnail on both the operation panel 15 and the terminal device 300.

For example, consider a case in which a plurality of documents is transmitted from an image processing device 200 to the image processing device 100 through facsimile communication, as illustrated in FIG. 6. In this case, the image processing unit 121 generates thumbnail data corresponding to each document from the image data indicating the content of such documents, as described above.

The thumbnail data generated by the image processing unit 121 is displayed on the operation panel 15 provided in the image processing device 100 by a predetermined operation of a user on the image processing device 100. Furthermore, a thumbnail image is displayed on the display panel of the terminal device 300 by a predetermined operation of a user on the terminal device 300. The user can then check the content of a document obtained by the image processing device 100 through facsimile communication with the operation panel 15 or the terminal device 300 before print out.

Such checking of the image can also be carried out for images retrieved by the scanner 17.

In the image processing device 100, a configuration in which the image processing unit 121 is commonly used by the main body unit 110 and the network unit 130 is adopted. Thus, the circuit size can be reduced compared to a conventional network multi-function peripheral. As a result, the component cost and device size can be reduced.

As described above, the image processing unit 121 is arranged on the circuit board 120 independent from the main body unit 110 and the network unit 130. Therefore, when designing and manufacturing a multi-function peripheral that does not require the image processing unit 121 and that simply requires only the network interface, the main configuration of the image processing device 100 can be used as is.

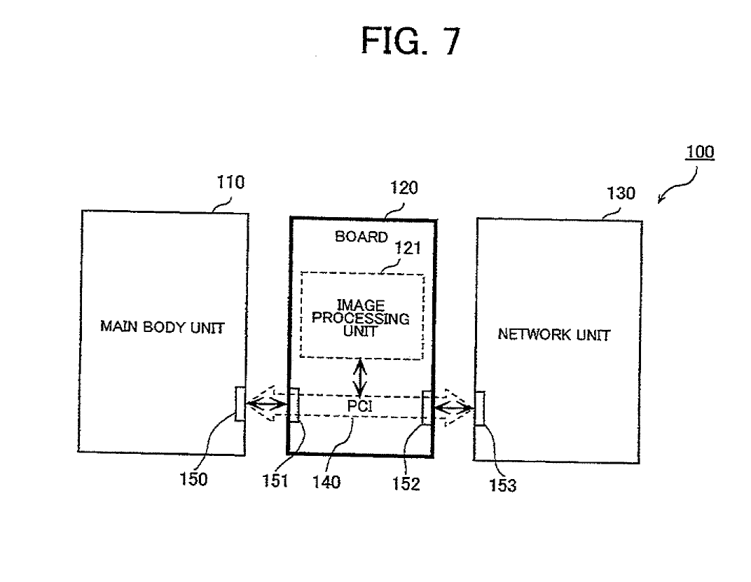

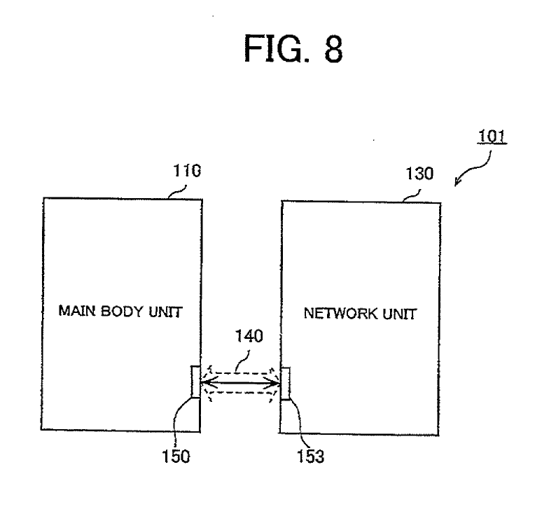

FIG. 7 illustrates a connection mode of the main body unit 110, the network unit 130, and the image processing unit 121 according to the present embodiment. FIG. 8 illustrates one example of the connection mode of the main body unit 110 and the network unit 130.

For example, as illustrated in FIG. 7, the main body unit 110 and the network unit 130 are physically connected by way of the circuit board 120 on which the image processing unit 121 is arranged.

To realize such a connection, the main body unit 110, the circuit board 120, and the network unit 130 each has a connector. Specifically, the main body unit 110 includes a connector 150, the circuit board 120 includes a connector 151 and a connector 152, and the network unit 130 includes a connector 153. By connecting the connectors with a cable and the like, the main body unit 110, the network unit 130, and the image processing unit 121 are connected as illustrated in FIG. 7.

The circuit board 120 may be detached from the image processing device 100 illustrated in FIG. 7, and the connector 150 of the main body unit 110 and the connector 153 of the network unit 130 may be connected with a cable. In this manner, an image processing device 101 that does not include an image processing unit 121 is configured, as illustrated in FIG. 8.

That is, the main body unit 110 and the network unit 130 can be easily connected with the PCI bus 140 even when the circuit board 120 including the image processing unit 121 is detached from the image processing device 100. In other words, the configuration of the image processing device 101 having the communication function with the external network can be easily realized.

Therefore, when designing a multi-function peripheral that does not require additional image processing such as generation of a thumbnail and that simply requires only a network interface, the configuration of such a multi-function peripheral can be easily designed from the configuration of the image processing device 100. Furthermore, the network unit 130 according to the present embodiment can be used for a multi-function peripheral that requires only a network interface.

Component parts and the like can be shared between a multi-function peripheral including the image processing unit 121 and a multi-function peripheral not including the image processing unit 121, and internal space can be reduced by the amount of the circuit board 120. As a result, design and manufacturing costs for a multi-function peripheral not including the image processing unit 121 can be suppressed.

An image processing device according to one aspect of the present invention has been described based on the above embodiments. However, the present invention is not limited to these embodiments. Modifications contrived by those skilled in the art may be made without deviating from the concept of the present invention. Embodiments contrived by combining the plurality of components described above are also encompassed within the scope of the present invention.

For example, the image processing device 100 according to the present embodiment has a printer function (printer 18), but the image processing device 100 does not necessarily need to have the printer function. Even if the printer function is not provided, the image processing device 100 may efficiently carry out the process of displaying the image acquired by the image processing device 100 on both the main body unit 110 and another device connected through the LAN 600.

Further, for example, the bus for connecting the main body unit 110 and the network unit 130 merely needs to be a general-purpose bus such as the PCI bus 140, and is not limited to a specific type of bus.

Further, for example, the storage 34 to which the thumbnail data is to be stored may be arranged not in the network unit 130 but in the circuit board 120 on which the main body unit 110 or the image processing IC 20 is mounted.

While the present invention has been described with respect to various embodiments thereof, it will be apparent to those skilled in the art that the disclosed invention may be modified in numerous ways and may assume many embodiments other than those specifically set out and described above. The appended claims are intended to cover all modifications that fall within the true spirit and scope of the present invention.

What is claimed is:

1. An image processing device comprising:
a scanner section for scanning an image of a document and generating image data;
a facsimile section for generating image data from a received facsimile signal;
a display section for displaying an image;
a first control section for controlling the scanner section, the facsimile section, and the display section;
an interface section for exchanging information with an external network;
a network unit including a second control section for controlling the exchange of information through the interface section;
a bus for connecting a main body unit and the network unit; and
an image processing unit, connected to the bus, for performing processing of the image data generated by the scanner section or the facsimile section according to a request of the first control section or the second control section, wherein
the display section displays an image based on the processed image data acquired by the main body unit, and
the interface section transmits the processed image data acquired by the network unit to the external network.

2. The image processing device according to claim 1, further comprising:
a circuit board independent from the main body unit and the network unit; wherein
the image processing unit is arranged on the circuit board.

3. The image processing device according to claim 1, wherein the image processing unit generates the processed image data by converting a resolution of an image in the image data generated by the scanner section or the facsimile section.

4. The image processing device according to claim 1, wherein
the bus is a Peripheral Component Interconnect bus; and
the first control section and the second control section respectively accesses the image processing unit by specifying a predetermined address.

5. The image processing device according to claim 1, wherein
the network unit further includes a storage unit for storing the image data generated by the scanner section or the facsimile section; and
the image processing unit generates the processed image data by reading and processing the image data stored in the storage unit, and writes the generated processed image data again to the storage unit.

6. The image processing device according to claim 3, wherein the processed image data is thumbnail-size image data.

7. The image processing device according to claim 6, wherein a set value transmitted from the external network, or a set value inputted by a user to the main body unit, is used to set a size of the thumbnail-size image data.

8. The image processing device according to claim 1, wherein
the main body unit comprises the display section, the facsimile section, the scanner section and the first control section, and
the network unit comprises the interface section and the second control section.

9. An image processing device comprising:
a scanner section for scanning an image of a document and generating image data;
a facsimile section for generating image data from a received facsimile signal;
a first control section for controlling the scanner section and the facsimile section;
an interface section for exchanging information with an external network;
a network unit including a second control section for controlling the exchange of information through the interface section;
a bus for connecting a main body unit and the network unit;
an image processing unit, connected to the bus, for performing processing of the image data generated by the scanner section or the facsimile section according to a request of the first control section or the second control section;
a display section for displaying an image based on the processed image data acquired by the main body unit; and
a transmitting unit for transmitting the processed image data acquired by the network unit to the external network.

10. The image processing device according to claim 9, further comprising:
a circuit board, which is provided with the image processing unit and which is independent from the main body unit and the network unit.

11. The image processing device according to claim 9, wherein the image processing unit generates the processed image data by converting a resolution of an image in the image data generated by the scanner section or the facsimile section.

12. The image processing device according to claim 9, wherein
the bus is a Peripheral Component Interconnect bus; and
the first control section and the second control section respectively accesses the image processing unit by specifying a predetermined address.

13. The image processing device according to claim 9, further comprising:
a storage unit, provided in the network unit, for storing the image data generated by the scanner section or the facsimile section; and
the image processing unit generates the processed image data by reading and processing the image data stored in the storage unit, and writes the generated processed image data again to the storage unit.

14. The image processing device according to claim 11, wherein the processed image data is thumbnail-size image data.

15. The image processing device according to claim 14, wherein a set value transmitted from the external network, or a set value inputted by a user to the main body unit, is used to set a size of the thumbnail-size image data.

16. The image processing device according to claim 9, wherein
the main body unit comprises the display section, the facsimile section, the scanner section and the first control section, and
the network unit comprises the interface section and the second control section.

17. An image processing method comprising:
generating image data with a scanner of a main body unit of an image processing device by scanning an image of a document, or with a facsimile of the main body unit from a received facsimile signal;
processing the image data with an image processing unit of the image processing device according to a request from the main body unit or according to a request received via a network unit of the image processing device from an external network;
when the request was from the main body unit, displaying an image based on the processed image data on a display section of the main body unit; and
when the request was from the external network, transmitting the processed image data to the external network for display on an external device connected to the external network, wherein
the image processing unit is independent of the main body unit and the network unit.

18. The image processing method according to claim 17, wherein the processed image data is generated by converting a resolution of an image in the image data generated by the scanner or the facsimile.

19. The image processing method according to claim 18, wherein the processed image data is thumbnail-size image data.

20. The image processing method according to claim 18, wherein a set value transmitted from the main body unit or from the network unit is used by the image processing unit to set a size of the thumbnail-size image data.
